(19) United States
(12) Patent Application Publication
(10) Pub. No.: US 2025/0252518 A1
(43) Pub. Date: Aug. 7, 2025

(54) SYSTEM AND METHOD FOR ADJUSTING DIGITAL CONTENT BASED ON USER ENGAGEMENT ASSESSMENT

(71) Applicants: Alemira AG, Schaffhausen (CH); Constructor Education and Research Genossenschaft, Schaffhausen (CH)

(72) Inventors: Svetlana Dergacheva, Sofia (BG); Serg Bell, Costa del Sol (SG); Stanislav Protasov, Singapore (SG); Laurent Dedenis, Singapore (SG); Nikolay Dobrovolskiy, Istambul (TR)

(21) Appl. No.: 18/434,201

(22) Filed: Feb. 6, 2024

(51) Int. Cl. G06Q 50/20; G06Q 30/0201; G09B 5/02

(52) U.S. Cl. CPC G06Q 50/20; G06Q 30/0201; G09B 5/02

(57) ABSTRACT

Systems and methods for assessing user engagement with digital materials combining a variety of data sources, including video images, user device activity, and derived data, to estimate user attention recovery time. User engagement can be proactively monitored, analyzed and optimized, thereby improving the learning experience for student users.

### TECHNICAL FIELD

The invention relates generally to digital content generation and representation, and more particularly to adjusting digital content based on user engagement and recovery of attention estimation.

### BACKGROUND

The Internet has made it possible for a user to electronically access virtually any content at any time and from any location. With the explosion of information, it has become increasingly important to provide users with information that is relevant to the user. Further, as users increasingly rely on the Internet as their source of information, entertainment, and/or social connections, e.g., news, social interaction, movies, music, etc., it is critical to provide users with information they find valuable.

Modern trends in educational software development are associated with adaptive learning systems, i.e. systems that can personalize the user's interaction with the system. One of the key quality indicators for educational software, which is characterized by intensive user interaction with the system, is engagement.

When studying digital materials (documents, training courses), the manager, customer, and teacher need to fully master the material. However, employees, students, and other users who get acquainted with digital material can perceive the material differently, for example, someone may be distracted or someone may focus on certain parts (for example, images, text, code or formulas). In order to increase the degree of user involvement in the material being viewed, in particular, to increase the student's involvement in the materials of the electronic course, an individual approach is needed for each student user without changing the learning process for other student users. A solution is needed that will allow adaptive change of the material and the course of its presentation in order to increase the perception of the material by the user, without changing the materials for other users.

Existing solutions address aspects of user engagement and customization in digital content delivery. However, such existing solutions lack specificity in evaluating user engagement, relying on behavioral methods without clear data sources. Rather, existing solutions focus on content personalization, application updating based on user interactions, and adaptive assessments in educational settings. Notably, these approaches are comprehensive but heavyweight, potentially causing performance degradation. Therefore, there is a need for a more lightweight and personalized assessment systems and methods for individual and group users.

### SUMMARY

Embodiments described herein apply engagement assessments to adapt learning processes in learning systems, including by use of metrics and metric interpretation as applied to engagement. A method of combined engagement assessment is presented, which makes it possible to take into account various aspects of possible manifestation of user engagement while interacting with the learning system. Metrics, indicators and rules for their convolution are proposed that are applicable to the online assessment of engagement in adaptive learning systems. Ways of using the developed method to adapt to the learning process in learning systems are considered.

To overcome the problems found in the state of the art, a system and method for adjusting digital content based on user engagement assessment was created. For example using a combination of data sources, including a video image, user activity on a device, and derived data to evaluate the engagement of each user and user group and training and using AI models for: face detection, emotion detection, focus detection and user engagement assessment, also estimation of the user's attention recovery time based on the received data and adaptive content change based on engagement score and recovery time for each user and user group.

Various systems level interceptors are used with special control flow points, such as Thread/Process Creation, File mapping etc., that allows re-estimation of the verdict for an application. Several iterations are used to achieve increasingly more accurate results like: content style change; material feed rate change; repetition of material; adding dynamic animation to draw attention; notification; gamification with motivation to follow the material for a score or a prize; inclusion of security questions; change in content (inclusion of additional materials or reduction of material); generating a report with a characteristic of user involvement when studying the material (for example, when testing different courses, video lectures, presentations) to rate materials.

In one embodiment, the method for measuring user engagement involves capturing raw data from the user's device. This includes video images from the webcam, input data from IO devices (e.g., mouse, keyboard), application activity data, and system events data. The method further involves training machine-learning models with the captured raw data. Specifically, distinct models are trained for face detection, emotion detection, focus detection, and user activity detection.

In further embodiment the machine learning model is configured for the analysis of video frames, and it is trained on a dataset specifically curated for face detection. Machine learning is utilized in processing the video data captured from the user's device, including video images from a camera and is tailored to identify and analyze faces within the video frames. The model's input is expressly designed to accommodate video data, aligning with its expertise in facial detection and related parameters.

In another embodiment the machine-learning models employed for emotion detection are designed to process and interpret the physiological signals. The machine-learning models are trained on datasets that associate specific physiological patterns with corresponding emotional states, allowing them to make inferences about a user's emotional state based on real-time physiological data.

In an embodiment, “physiological data” encompasses a range of biological measurements that may include but are not limited to heart rate, skin conductance, facial muscle activity, and other bodily responses indicative of emotional states. The physiological signals are collected through specialized sensors or devices capable of capturing such data.

In a further embodiment the machine-learning models use pattern recognition techniques to analyze the extracted features and generate assessments of the user's emotional state. The trained models are capable of distinguishing between a range of emotions, such as joy, sadness, excitement, and so forth.

Additionally, each user session is associated with corresponding events and event parameters. Marked events, representing user actions and behaviors, are utilized to calculate the total time of user focus for each session, referred to as “focus time.” The method assesses changes in user engagement scores throughout each session using marked events, their parameters, and focus time. An attention recovery time is estimated by analyzing the time interval between focused events and interruptions. The digital content is then dynamically adjusted for a particular user based on calculated engagement score, focus time, and attention recovery time. The adjustment involves methods such as adaptive content change, content style modification, repetition of material, and the inclusion of dynamic elements to enhance engagement. A report with user involvement ratings is generated, providing insights into engagement levels, attention recovery, and other relevant metrics.

In another aspect of the present invention the system for user engagement assessment empowers educational institutions and administrators with tools to monitor, analyze, and optimize user engagement and learning experiences. The system utilizes a student workstation equipped with a comprehensive data collection module, capturing various data types through components like the desktop screening unit, web-camera control unit, system events control unit, and application activity control unit.

In an embodiment, the data collection module captures a wide range of user interactions, including screen images, webcam video, device inputs, application activities, and system events. The comprehensive data collection offers a detailed overview of user engagement.

In an embodiment, the engagement analysis service processes the collected data to generate raw engagement events, serving as the foundation for further analysis.

In another embodiment, the data aggregation module takes the raw engagement events and aggregates them, providing meaningful metrics for both individual clients and groups.

In yet another embodiment, the reporting module receives aggregated data and offers administrators a graphical monitoring interface. The interface visually represents engagement data over time, empowering administrators to make informed decisions about content adjustments and improvements.

In a further embodiment, the content adjustment module collaborates with the Learning Management System (LMS) to dynamically modify content based on engagement data. This ensures a personalized and effective learning experience, catering to individual preferences and learning styles.

### BRIEF DESCRIPTION OF THE DRAWINGS

Subject matter hereof may be more completely understood in consideration of the following detailed description of various embodiments in connection with the accompanying figures, in which:

FIG. 1 is a block diagram of a distributed e-learning system, according to an embodiment.

FIG. 2 is a block diagram of a system for monitoring events at a workstation, according to an embodiment.

FIG. 3 is a block diagram of an engagement assessment system, according to an embodiment.

FIG. 4 is a block diagram of a system for controlling video images from a user workspace, according to an embodiment.

FIG. 5 is a block diagram of a system utilizing desktop and device data streams received from a browser, according to an embodiment.

FIG. 6 is a table of user session events, according to an embodiment.

FIG. 7 is a graph of engagement level during a user session, according to an embodiment.

FIG. 8 is a graph of client attention recovery time, according to an embodiment.

FIG. 9 is a flowchart of a method for measuring user engagement, according to an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

Embodiments described herein generally relate to adjusting to digital content based on user engagement assessment. More particularly, embodiments relate to systems, hardware, software, computer-readable media, and methods for adaptively aspects remote learning including student engagement, student interest, remote learning effectiveness, and other learning-related assessments.

Embodiments described herein includes various engines, also called “units” or “modules”, each of which is constructed, programmed, configured, or otherwise adapted, to autonomously carry out a function or set of functions. The term engine as used herein is defined as a real-world device, component, or arrangement of components implemented using hardware, such as by an application specific integrated circuit (ASIC) or field-programmable gate array (FPGA), for example, or as a combination of hardware and software, such as by a microprocessor system and a set of program instructions that adapt the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each engine can be realized in a variety of physically realizable configurations, and should generally not be limited to any particular implementation exemplified herein, unless such limitations are expressly called out. In addition, an engine can itself be composed of more than one sub-engines, each of which can be regarded as an engine in its own right. Moreover, in the embodiments described herein, each of the various engines corresponds to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

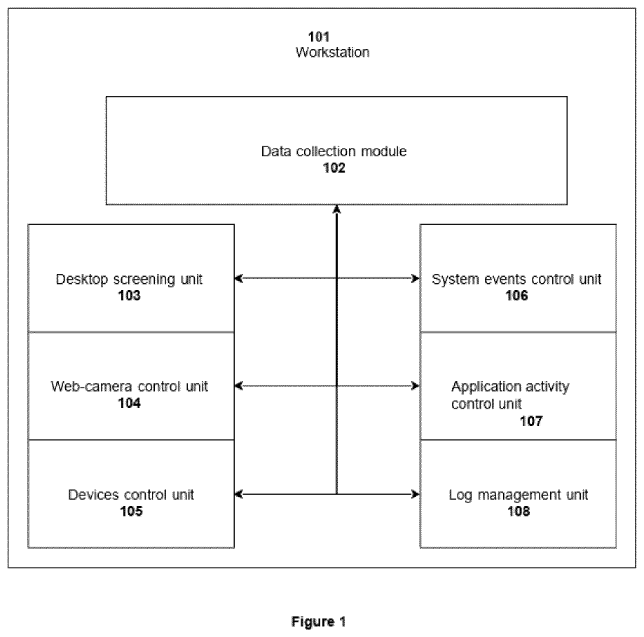

Referring to FIG. 1, a block diagram of a distributed e-learning system is depicted, according to an embodiment. As depicted. FIG. 1 includes a student workstation 101 implemented with a data collection module 102. In the course of a student's work with digital content, in particular when working with educational materials, for example, through a web browser or in the learning platform client interface, the data collection module 102 collects information about the user's activity. In one embodiment, the data collection module 102 comprises: a desktop screening unit 103, a web-camera control unit 104, a devices control unit 105, a system events control unit 106, an application activity control unit 107, and a log management unit 108.

Desktop screening unit 103, is configured to periodically, or in response to a particular event, capture a screen image and determine the changes or the current display state. A trigger event can initiate a desktop screen capture and can include at least one of user input, time counter, an administrator request, etc.

The web-camera control unit 104 is configured to collect data from a web-camera. In a particular embodiment, a web-camera control unit 104 captures video input from the camera. In another embodiment, a web-camera control unit 104 captures images from the web-camera within some period of time or in response to external events, similar to trigger events for desktop screening.

The device control unit 105 is configured to oversee and coordinate the behavior and interactions of various devices. In a particular embodiment, device control unit 105 manages communication between the devices and the rest of the system. In another embodiment, device control unit 105 controls specific operations and settings or facilitates data transfer.

The system events control unit 106 is configured to control system events according to a system event type. The system event type includes running software, switching between windows, copying data, screenshot, capturing graphics card image, transferring data over the network, connecting an additional screen, opening a remote desktop session, or changing operating system configurations.

The application activity control unit 107 is configured to coordinate the activities and processes of applications, corresponding to data, memory, network or UI operations.

The log management unit 108 operates with internal and external logs, containing events corresponding to workstation, used to generate, transmit, store, analyze, and dispose of log data. The log management unit 108 can utilize aggregation of data from multiple log sources. In a particular embodiment, the data aggregation is application logs, which are generated when an event occurs in an application. In another embodiment, a log management unit 108 captures system logs which events generated within the OS, like driver errors during start-up, sign-in, and sign-out events, among other activities.

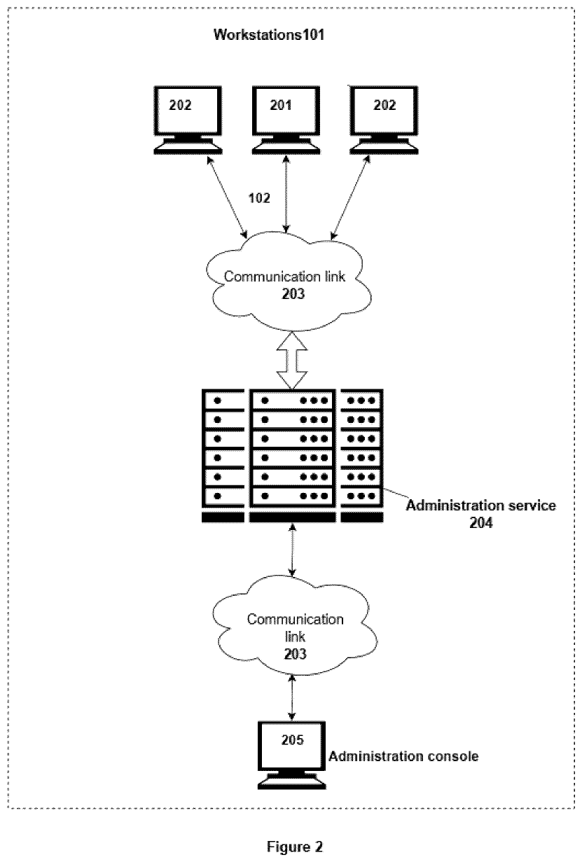

Referring to FIG. 2, a block diagram of a system for monitoring events at a workstation 101 is depicted, according to an embodiment. In particular, an e-learning platform is depicted, wherein one or more workstations 101 can interact with the e-learning platform administered by administration service 204. The e-learning platform administers the distribution of materials to users, manages user engagement, and offers administrator controls and reports through administration console 205. The administration console is communicatively coupled with administration service 204 to monitor events at workstation 101. The data collection module 102 can aggregate events from one client 201 or aggregate events from several clients 202 networked via communication link 203 operating over the Internet through which data is exchanged between workstation 101 and administration service 204. Administration service 204 can be implemented by physical and/or virtual servers, including centralized and/or distributed servers.

The workstation 101 can be a desktop computer, a laptop, a mobile device, and so on, such that workstation 101 is configured to interact with the e-Learning platform. The workstation 101 communicates with the administrative service 204 through a communication link 203.

The data collection module 102 collects events from individual clients (client 201) or groups of clients (clients 202) connected to the platform through a communication link 203.

The communication link 203 operates over the Internet and can be implemented by public networks such as the Internet, a mobile network, a wired network, a wireless network, and so on. The communication link 203 facilitates data exchange between the user workstations 101 and the administration service 204.

The administration service 204 includes a console for administrators to control the system and access reports. In a particular embodiment, the administration service 204 monitors events and administers the e-learning platform. In an embodiment, the administration service 204 collects data and assesses engagement level. The administration service 204 also provides administrative features to administrators, like reports, statistics and assessed metrics-per user 201 or per group 202. In an embodiment, the administration service 204 is operably coupled to workstations 101 and collects data from the data collection module 102.

The administration console 205 is a user interface that allows administrators to monitor, manage, and control various aspects of the e-learning platform.

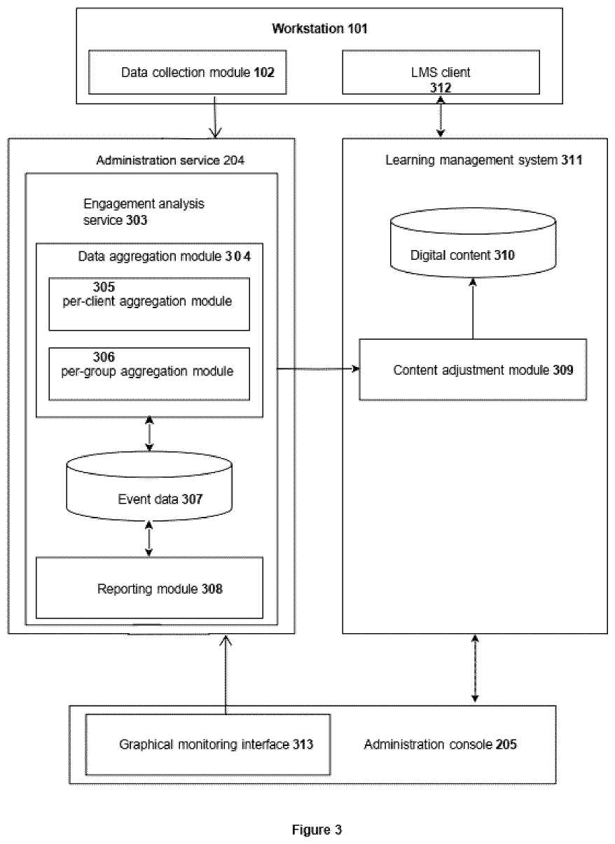

Referring to FIG. 3, a block diagram of an engagement assessment system is depicted, according to an embodiment. The block diagram of FIG. 3 depicts the flow of data, the relationships between different modules, and how user engagement data is collected, analyzed, and utilized within the system.

In one embodiment, each module within the system can be implemented using at least one processor, memory, and a network interface for data and command exchange between user and administrator devices via communication links.

In another embodiment, the modules may also be implemented as computer program modules, libraries, wrappers, applications, or software packages. In a partially embodiment, the modules may be written in various programming languages, such as C, C++, C#, Java, Python, Perl, or Ruby, depending on their specific functions.

Data collection module 102 collects, generates, and sends data to administration service 204, where the engagement analysis service 303 receives raw events. Engagement analysis service 303 preprocesses the raw events, which can include operations such as filtering, normalization, parsing, merging, splitting, grouping, and sorting, before storing the data in event data 307 storage. In one embodiment, events are processed using pre-trained machine-learning techniques to filter, normalize, parse, merge, split, group, sort, and correlate. In one particular aspect, the machine learning processes are primarily executed by dedicated components designed for video analysis within the system. Specifically, the machine learning model is crafted for the analysis of video frames, and it is trained on a dataset specifically curated for face detection. The machine learning model is thus configured to process the video data captured from the user's device, including video images from a camera and is tailored to identify and analyze faces within the video frames. The model's input is expressly designed to accommodate video data, aligning with its expertise in facial detection and related parameters. The preprocessing operations are performed selectively based on the specific requirements of the events. Data aggregation module 304 operates with data stored in event data 307 storage, and it is configured to perform two functions: aggregation of events through per-client aggregation module 305 and per-group aggregation module 306. Specifically, these operations ensure relevant and meaningful data is extracted for further analysis.

In one embodiment, machine learning is trained on footage that refers to the video data captured from the user's device, specifically video images recorded by a camera. This footage is a component for the system's machine learning models as it provides the visual data necessary for face detection and analysis. The video frames within this footage are analyzed by the system's models to identify and interpret user facial expressions and reactions, thereby contributing to the assessment of user engagement and emotional responses.

In another embodiment, the dataset for face training is utilized for training machine learning, and signifies a collection of facial images used to train the machine learning models for accurate face detection. The dataset for face training is distinct from the video footage as it serves as the foundational training material for the models. The dataset for face training consists of a diverse range of facial images, annotated with various expressions, orientations, and environmental conditions. Training the models on the dataset for face training ensures that the models can accurately detect and analyze faces in the video footage, regardless of varying facial features, expressions, or lighting conditions.

Footage and datasets for face training are utilized by embodiments of the system. Footage and datasets each serve a specific purpose: the footage as the source of real-time user data for analysis, and the dataset as the essential training material for the machine learning models.

The invention utilizes advanced machine learning models to enhance the assessment of user engagement and fatigue during digital content interaction. One such model is the Event Detection Model, a neural network-based framework designed to accurately identify and classify user behaviors such as chewing/talking and yawning. This model is adept at analyzing sequences of key points extracted from video input, distinguishing these behaviors based on their unique characteristics. A notable feature of this model is its capability to merge similar behaviors, like chewing and talking, into a single class, thereby streamlining the classification process.

In addition to the Event Detection Model, the system employs a Blink Detection model. This model operates on a principle of spatial analysis, focusing on the proximity of eyelid points to determine the state of eye closure. It is trained to differentiate between open and closed eye states under various conditions, making it a reliable indicator of user attention and potential fatigue.

These models are trained on a comprehensive dataset comprising annotated videos that depict a wide range of user behaviors. The training process is meticulously designed to ensure that the models can accurately interpret these behaviors in a real-world context. Validation of the models involves a rigorous comparison of their predictions against actual events in labeled videos, ensuring high accuracy and reliability in user engagement assessment.

As an embodiment of the given machine learning models, The Gaze Direction Model exemplifies the system's capability in advanced user behavior analysis. This model, employing facial landmark analysis, estimates the user's gaze direction and head orientation, providing insights into where the user's attention is focused.

In one embodiment per-client aggregation module 305 calculates characteristics for individual clients. In an embodiment, characteristics can include attention, engagement, and recovery time characteristics for individual clients. In an embodiment, a client is associated with one student user.

In another embodiment per-group aggregation module 306 is configured to calculate and provide statistics about performance levels for multiple clients grouped together.

Event data 307 that is collected by the data aggregation module 304 is sent to the adjustment module 308, which is an additional tool for retrospective analysis of the collected data to improve the quality of digital content. In embodiments, all event data 307 of portions of event data 307 that is collected is sent to the adjustment module 308.

Newly collected user data refers to the latest set of data points and interactions gathered from users as they engage with digital content. This data is continuously acquired in real-time and includes a wide array of user actions, such as click patterns, time spent on different sections of the content, responses to interactive quizzes, and navigation paths through the content. The system can also collect data on user preferences, such as favored content types or topics, and their responses to different content formats. This newly collected user data is essential for keeping the machine-learning models updated and relevant, ensuring that they reflect the current behaviors and preferences of the user base.

Detection accuracy refers to the precision and reliability with which the machine-learning models can interpret and respond to the collected user data. Enhanced detection accuracy means that the models are better equipped to accurately identify and understand user behaviors, emotional states, and engagement levels than existing systems. Improving detection accuracy involves refining the models to reduce false positives or negatives in recognizing user engagement patterns. Improved detection accuracy can include training the models on more diverse and comprehensive datasets, fine-tuning model algorithms to better discern subtle user interactions, and continuously validating model predictions against real-world user responses. Enhanced detection accuracy leads to more effective and personalized adjustments to the digital content, ensuring that the adjustments resonate more strongly with the user's preferences and engagement style.

The association of user sessions with corresponding events and event parameters is integral in the engagement assessment process. The machine-learning models disclosed herein play a crucial role in generating these events based on the collected user data. Specifically, the machine-learning models for face detection, emotion detection, focus detection, and user activity detection contribute to the identification and characterization of events. The events are derived from the analyzed data, reflecting the user's behavior, emotional state, focus level, and activity patterns during a session. Therefore, the events are indeed outcomes of the machine-learning operation, illustrating how the models' analyses inform the assessment of user engagement.

In one embodiment, the event parameters output is configured to capture an array of user interaction metrics within the digital content adjustment system. This output includes advanced analysis of user responses to interactive elements embedded in the digital content. For instance, the system can measure the response time and accuracy when users engage with quizzes or tasks in a gamified environment. These metrics provide insights into the user's engagement and comprehension levels.

In another embodiment, the event parameters output incorporates the analysis of keystroke dynamics. This aspect of the system can analyze typing patterns, such as speed and rhythm, to gauge the user's engagement and emotional state. Patterns in keystrokes can indicate varying levels of interest or frustration, thereby contributing to a comprehensive assessment of user engagement.

Additionally, the event parameters output includes the utilization of eye-tracking data. This feature of the system can determine focal points on the screen, identifying areas that attract the most attention or might be sources of confusion for the user. Furthermore, the system can implement voice tone analysis during interactions with voice-enabled digital content. This analysis can assess emotional responses like excitement or boredom, enhancing the overall user engagement assessment.

Moreover, the system can generate one or more heatmaps based on mouse movement data.

These heatmaps visually represent areas on the screen that attract maximum user attention, such that more frequent user attention is presented as “hotter,” thus aiding in the strategic adjustment of digital content.

The event parameters output, as integrated into the digital content adjustment system, significantly enhances the ability to dynamically assess and respond to user engagement. Each of these features contributes to a nuanced understanding of user behavior and interaction with digital content, according to an embodiment.

The reporting module 308 provides a graphical monitoring interface 313. The graphical monitoring interface 313 displays statistics of the customer's engagement with content against the timeline in an administration console 205. In an embodiment, administration console 205 allows administrators to access the learning management system (LMS) 311. The reporting module 308 serves as a tool for retrospective analysis of aggregated data to improve the quality of digital content. In one embodiment the reporting module 308 provides a graphical interface. The graphical interface displays engagement-related data in the form of charts, graphs, and/or tables. Visualizations provided by the reporting module 308 offer administrators a clear view of user engagement patterns and trends over time. In another embodiment, the reporting module 308 provides customizable reports, where administrators can customize the type of reports they want to generate based on their specific needs. Administrators can choose to focus on different engagement metrics, such as emotion data, focus time, recovery time, and survey responses. In an embodiment the reporting module 308 provides detailed analysis of different digital content types. For instance, the reporting module 308 offers a comprehensive analysis of how users engage with various content types, including videos, quizzes, presentations, and more. In an embodiment, the reporting module 308 furnishes insights into engagement levels by employing sophisticated algorithms that analyze user interaction data. The reporting module 308 distinctly highlights periods characterized by high and low engagement by considering factors such as the duration of user interactions, the type of content being accessed, and the frequency of interruptions. The functionality empowers administrators to discern effective content segments and areas that necessitate improvement, enabling administrators to make data-driven decisions.

In an embodiment, the reporting module 308 provides administrators with sophisticated tools for analyzing engagement trends across multiple sessions and clients. This is accomplished by aggregating and comparing engagement data from various sources, including individual user sessions and group statistics. Administrators can access detailed reports that break down engagement metrics by session duration, content type, and user demographics. The reporting module 308 facilitates the recognition of recurrent patterns and allows administrators to make informed decisions concerning content adjustments. Moreover, the reporting module 308 introduces a color-coded system (utilizing green, yellow, and red) to represent engagement percentages in client sessions. The color-coded system is a visual indicator generated through an algorithm that assesses engagement metrics against predefined thresholds. The algorithm takes into account parameters such as the ratio of focus time to interruption time and the average attention recovery time. The system then assigns a color code to each session based on these metrics. The visual cue promptly conveys the level of engagement within each session. As an illustrative scenario, administrators can conduct comparisons of engagement metrics across different clients, sessions, or content types, allowing for benchmarking and the identification of best practices for enhancing engagement.

In yet another embodiment, the reporting module 308 provides administrators the ability to export the generated reports in a variety of formats, including PDF, Excel, or CSV. This is achieved through a user-friendly interface that allows administrators to select the desired format and content parameters. Once configured, the reporting module 308 generates the report in the chosen format, making it easily shareable and facilitating collaboration among stakeholders.

Furthermore, the reporting module 308 is configured to be interactive in embodiments. Interactive functionality is implemented through a web-based interface that allows administrators to interact with data points on engagement charts and access detailed information about individual events within a session. Administrators can zoom in on specific time periods, click on data points to view event logs, and even set custom alerts for specific engagement thresholds. This level of interactivity provides administrators with a more granular view of user engagement data, empowering administrators to take immediate action when needed.

Additionally, the reporting module 308 can incorporate user feedback data in a further embodiment. This is achieved by integrating user surveys and sentiment analysis tools into the reporting interface. Administrators can create custom surveys to gather feedback from users about their learning experience. The sentiment analysis tools automatically analyze text responses and provide sentiment scores, allowing administrators to understand user satisfaction and opinions about the content. For instance, administrators gain access to real-time reports for ongoing sessions, as well as historical reports for past sessions, offering a comprehensive view of the evolution of engagement.

The graphical monitoring interface 313 provides a visual representation of engagement data, enhancing administrators' ability to monitor and assess user behavior and engagement patterns within the e-learning platform and accessible through the administration console 205, which gives administrators centralized access to various tools and controls related to the e-learning system. In one embodiment graphical monitoring interface 313 presents statistics, trends, and patterns related to user engagement over a specified timeframe.

In one embodiment, the graphical monitoring interface 313 delivers comprehensive statistics, trends, and/or patterns related to user engagement over a predefined timeframe. Administrators can specify the time range they wish to analyze, allowing administrators to examine engagement dynamics on a daily, weekly, or monthly basis, among other timeframes.

In an embodiment, the graphical monitoring interface 313 adopts various graphical elements to present user engagement data. The elements include but are not limited to charts, graphs, tables, and intuitive visual aids. Visuals offer administrators an intuitive and insightful representation of how users are interacting with the digital content. For instance, administrators can view line graphs depicting engagement trends over time, pie charts illustrating the distribution of user engagement by content type, or heatmaps revealing peak engagement hours.

The learning management system (LMS) 311 is a software application or platform designed to facilitate the creation, delivery, management, and evaluation of educational courses, training programs, or learning content. In one embodiment the learning management system 311 is operably coupled to the administration service 204, and more particularly, to the engagement analysis service 303 to obtain an individual client metrics or client group's engagement metrics. In an embodiment, LMS 311 is further configured to modify digital content 310 using content adjustment module 309.

The digital content 310 can include educational materials, courses, presentations, quizzes, videos, and interactive simulations in documents formats like .doc, .pdf, .xls, .ppt, video formats, audio formats, AI-avatars, AI-chats.

The content adjustment module 309 collaborates with the LMS 311 to dynamically modify content based on engagement data, thus contributing to a more personalized and effective learning experience. In one embodiment, the content adjustment module 309 analyzes data and user engagement information collected from the data collection module 102 and makes adjustments to the content accordingly. The adjustments can include changes to the format, difficulty level, structure, or delivery of the content to better suit the needs and engagement of the learners. In another embodiment, the content adjustment module 309 is configured to enhance the learning experience by tailoring content to match user preferences and learning styles.

In one example, for educational materials like documents in formats such as .doc, pdf, .xls, and .ppt, the content adjustment module 309 enhances engagement by identifying lengthy passages that may cause disengagement. The content adjustment module 309 automatically inserts interactive elements like in-text quizzes, hyperlinked reference materials, or multimedia components e.g., embedded videos or simulations at appropriate points within the document. For instance, while reading a lengthy document on history, students might encounter pop-up quizzes to reinforce their understanding of key concepts.

In another example, in the context of online courses, the content adjustment module 309 identifies challenging topics or sections based on user performance data. For example, if a significant number of learners struggle with a specific learning module, the content adjustment module 309 automatically supplements the difficult learning module with additional resources such as explanatory videos, interactive simulations, or supplementary readings. Presentations are optimized for remote learning scenarios by breaking down extensive presentations into smaller, more digestible sections. Interactive navigation options allow learners to choose which sections to explore based on their interests or learning pace. For instance, a lengthy business presentation may be divided into sections, and learners can navigate through the slides they find most relevant. Quizzes are adjusted based on individual learner performance. Learners who excel consistently receive progressively challenging questions, while those who struggle receive simpler questions along with detailed explanations to facilitate comprehension.

In an example of video content, the content adjustment module 309 identifies points of disengagement and introduces interactive elements like pop-up quizzes, reflection prompts, or clickable links to additional resources. This keeps viewers actively engaged throughout the video.

Complex interactive simulations are simplified for learners who require additional support. The content adjustment module 309 offers guided walkthroughs with step-by-step instructions to help learners understand the simulation's concepts. Advanced learners receive more complex simulations or more challenging scenarios to maintain their engagement. In Audio Content, learners can adjust the playback speed to suit their preferences, allowing for quicker comprehension or improved understanding and note-taking. In AI-driven content like AI-Avatars and AI-Chats, the content adjustment module 309 adapts communication styles and content recommendations based on user interactions and preferences. For instance, if a user prefers a more conversational style, the AI-avatar engages in casual conversation while delivering educational content.

In another embodiment, the system is configured to modify the format of content presentation, thereby adjusting content. Modifying format can include changing the content from text-based to more visually engaging formats like videos or interactive graphics, depending on the user's engagement patterns. Additionally, the system can incorporate interactive elements, such as quizzes or gamification techniques, to increase user engagement. These interactive elements are designed to captivate the user's attention and encourage active participation with the content.

In another embodiment, the system can adjust digital content by integrating adaptive learning algorithms that modify the difficulty level of the content based on user engagement scores. For example, if the system detects a high level of user engagement and comprehension, it can automatically introduce more complex or advanced topics. Conversely, if the engagement scores indicate a lack of understanding or decreased interest, the system can simplify the content, offering more basic explanations or revisiting foundational concepts. This adaptive approach ensures that the content remains challenging yet accessible, optimizing the learning experience for each user.

Additionally, the system is capable of altering the sensory modalities of the content presentation to cater to different learning styles. For users who show increased engagement with auditory information, the system can emphasize audio elements such as voice-overs or sound effects. For visually-oriented users, the content can be adjusted to include more graphical representations, charts, and infographics. This multimodal approach to content presentation ensures a more inclusive and effective learning experience, catering to diverse user preferences and cognitive styles.

Furthermore, the system can implement real-time feedback mechanisms within the digital content. These mechanisms can provide users with immediate responses to their interactions, such as congratulatory messages for correct answers in quizzes or constructive feedback for incorrect responses. This instant feedback can enhance user engagement by making the learning process more interactive and responsive.

In another embodiment, the system can utilize user engagement data to dynamically organize and sequence content topics. Based on the engagement scores and user interaction patterns, the system can reorder the topics to present the topics in a sequence that maximizes user interest and comprehension. This dynamic sequencing ensures that the content flow is aligned with the user's learning pace and preferences.

In an embodiment, updated digital content 310 is provided to a student user through LMS client 312, which can execute or otherwise be accessible (e.g. in a web browser) on workstation 101.

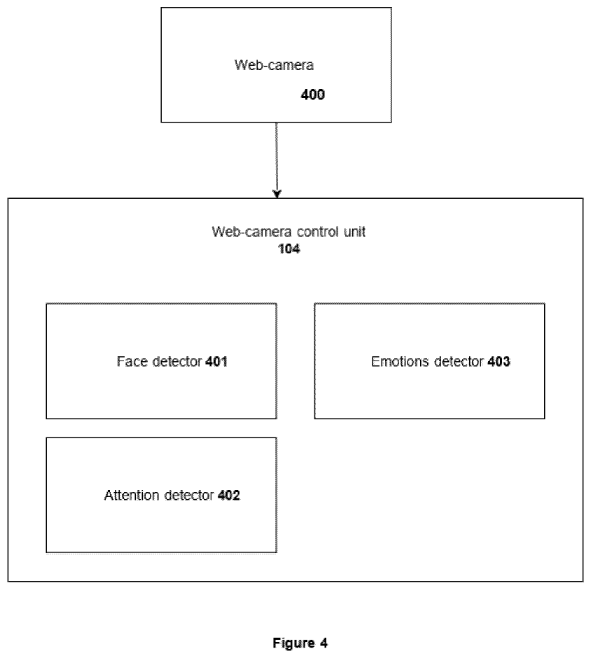

Referring to FIG. 4, a block diagram of a system for controlling video images from a user workspace is depicted, according to an embodiment. The block diagram illustrated in FIG. 4 depicts a web camera capturing video (Web-camera 400), a control unit managing the camera's operation (Web-camera Control Unit 104), and software components that analyze the captured video. A face detector 401 identifies faces, an attention detector 402 gauges the user's attention, and an emotions detector 403 assesses the user's emotional responses.

The face detector 401 is configured to identify and locate human faces within the captured video frames. Face Detector 401 uses facial recognition techniques to detect the presence and position of faces.

The attention detector 402 is configured to assess the level of attention or focus displayed by the user. In one embodiment, an attention detector 402 analyzes various cues like eye movement, head orientation, and other factors to estimate the user's attention to the video content.

The emotions detector 403 is configured to analyze facial expressions and other visual cues to determine the user's emotional state. In one embodiment, an emotions detector 403 identifies emotions like happiness, sadness, surprise, etc., based on the user's facial features.

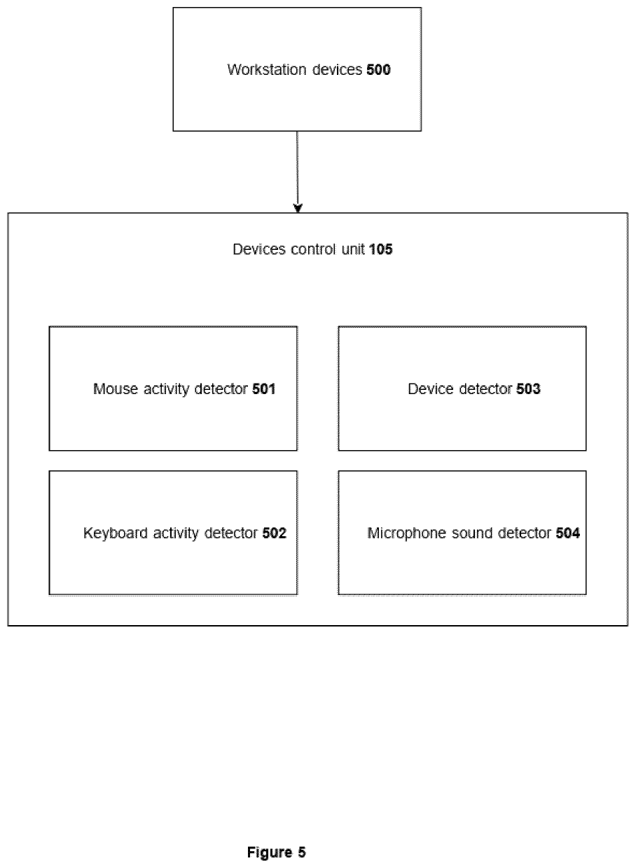

Referring to FIG. 5, a block diagram of a system utilizing desktop and device data streams received from a browser is depicted, according to an embodiment. In particular, FIG. 5 provides a visual representation of a particular scenario involving data streams originating from a user's browser. In this scenario, the diagram showcases how the system interacts with the user's hardware components referred to as workstation devices 500. Workstation devices 500 can include elements like the computer, monitor, keyboard, mouse, and microphone. The system further involves specialized modules to process and interpret various user interactions.

A mouse activity detector 501 is configured to capture mouse-related actions such as movements, clicks, and gestures.

A keyboard activity detector 502 is configured to identify and capture keyboard input, which includes individual key presses and combinations.

A device detector 503 is configured to recognize and categorize the different types of devices connected to the user's workstation 101.

A microphone sound detector 504 is configured to capture and process audio input from the user's microphone.

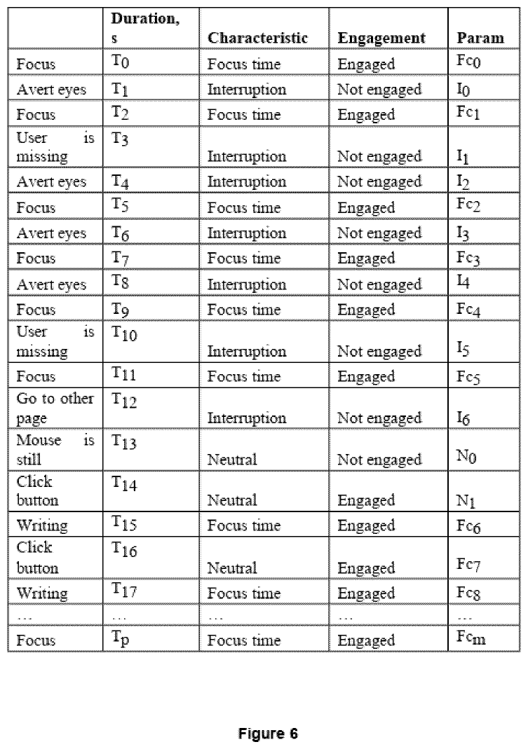

Referring to FIG. 6, the table provides a detailed overview of user session events, offering a comprehensive record of various interactions within the digital environment, as per an embodiment. The table serves as a tool for tracking and analyzing user engagement behaviors during an interaction session. Each row in the table corresponds to a distinct event, capturing crucial details regarding duration, event characteristics, engagement parameters, and focus states. The information presented in the columns is pivotal for understanding the dynamics of user engagement throughout the session. Duration, s (T): The duration column represents the time duration of each specific event, measured in seconds and indicates how long each engagement event or interruption lasted during the user session. The “Characteristic” column describes the nature or type of the event. For example, the “Characteristic” column can include events such as focusing on content, averting eyes, interacting with the mouse, clicking buttons, writing, or engaging in other activities within the digital environment. The “Engagement Parameter” column outlines the engagement parameter associated with each event and provides a quantifiable measure of the user's level of engagement during a specific event. Parameters such as “Engaged,” “Not Engaged,” or “Neutral” may be assigned based on the nature of the event. The “Engagement” or otherwise called “Focus State” column indicates the user's focus during each event. For events related to focusing on content, the focus state might be marked as “Engaged.” In contrast, events like interruptions or instances where the user is missing may result in a “Not Engaged” focus state. The “Param” column illustrates example parameters for the event behavior.

As used herein, the term quantifiable measurements refers to specific, measurable data points collected and analyzed by the system to evaluate user interaction and involvement with digital content. Quantifiable measurements can include a wide range of metrics such as the number of clicks, the frequency of page visits, time spent on each section of the content, and the rate of content completion. Additionally, quantifiable measurements can include more sophisticated metrics such as the number of interactions with interactive elements in the content, like quizzes or clickable infographics. The system can use measurements to assess how effectively the digital content engages the user, providing valuable insights for content optimization.

User focus duration is a specific type of quantifiable measurement that the system uses to gauge the attention span of the user while interacting with digital content. This metric measures the length of time a user remains actively engaged with the content, indicated by continuous interaction or sustained viewing patterns. User focus duration can be determined through various methods, such as tracking the movement of the user's cursor, analyzing eye-tracking data to monitor viewing patterns, or assessing user interactions with the content over time.

In the process of scrutinizing user engagement and focusing on digital content, a methodical analysis of raw events can be utilized. Each individual event is subject to a comprehensive assessment, encompassing both its duration and inherent characteristics. In embodiments, individual events can be analyzed alone or in combination with other events, such as a series of events or a time-based selection (e.g. each event occurring in a time period such as every 30 seconds), etc.

The significance of events in the context of user engagement is meticulously evaluated. A positive or negative value is attributed based on the user's involvement. Furthermore, events are examined through the lens of their impact on focusing on digital content. These evaluations lead to the assignment of distinct characteristics: Focus time is denoted as ‘Fc,’ Interruption as ‘I,’ and Neutral as ‘N.’

Central to this process is the magnitude of each event, defined by its duration. This duration, often likened to the event's magnitude, spans from the very moment the event is initially recognized by the neural network. It extends until another event commences or the ongoing event concludes. An illustrative instance, such as ‘looking away,’ underscores the concept effectively

The dynamic interplay between students and the learning environment is encapsulated by student sessions, demarcated by neural networks. These sessions consist of an array of events, providing a comprehensive representation of the student's interaction. From this intricate array of events, a subset is selected to constitute a sample. This sample assumes a structured form, encompassing event duration (T), engagement context (Fc/I/N), and the count of events (p). This collective data serves as the foundation for one or more subsequent calculations. In an embodiment, a designated buffer area executable can be rendered, followed by the transition of execution to that designated area. This technical embodiment ensures the coherent execution of the process.

In an embodiment, the meticulous and systematic approach to event analysis utilizes a formula according to:

$$Max Focus = {\sum }_{i = 0}^{m} {F}^{′} ( t ) \frac{{t}_{e}}{{t}_{all}} .$$

The formula calculates the maximum focus score and involves the following operations:
Preselection of Focused Events: Events marked as focused are preselected from the overall array of events.
Calculation of F Values: The F values are calculated for each focused event using the formula F\hat{ }′ (t) t_e/t_all. Here:
F\hat{ }′ (t) represents the engagement context (Fc/I/N) of the event.
t_e is the duration of the focused event.
t_all is the total duration of all conducted sessions.

Summation of F Values: The calculated F values for each focused event are then summed up using the summation symbol Σ_(i=0)\hat{ }m, where ‘m’ represents the total number of focused events.

In one embodiment the marked events refers to the events and their corresponding parameters that have been identified and recorded during a user session. The marked events are the specific instances of user interactions, behaviors, and system events that have been processed and analyzed using machine-learning models. The calculation of the total time of user focus is based on marked events, which collectively provide insights into the user's engagement level throughout the session.

In the context of the present disclosure, the term ‘calculated engagement score’ is a quantitative representation obtained through the analysis of diverse user engagement data. The analysis encompasses critical factors, including but not limited to face detection, emotion detection, focus detection, and user activity detection. The calculated engagement score encapsulates the intricate dynamics of user interactions with digital content, providing a numerical metric that signifies the extent of the user's engagement.

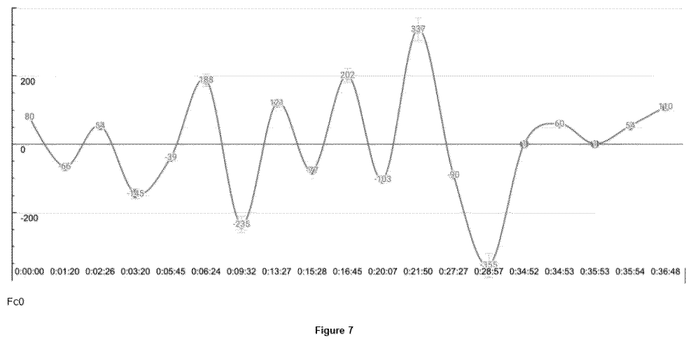

Referring to FIG. 7, a graph illustrating the engagement level during a user session is depicted, as per an embodiment. Each data point on the graph corresponds to the start time and duration of individual events, contributing to the placement and size of the points. The visual representation effectively demonstrates the dynamic changes in user engagement over the course of their interaction with digital materials. The graph is founded on data derived from the system's assessment of user behaviors and engagement patterns during a session. The depicted graph visually portrays the temporal distribution of user engagement by correlating the initiation times and durations of individual events within the user session and serves as a visual tool for understanding the fluctuations and variations in user engagement, capturing the ebb and flow of attention and interest across the duration of the session.

In one embodiment, the total time during which the user maintains focus and engagement is computed using the previously established formula. The computation allows for the quantification of the user's sustained attention, a pivotal factor in evaluating their engagement with the digital content.

In another embodiment, the analysis of session data constructs the engagement graph, providing a visual representation of evolving engagement levels during the user's interaction session with digital content. The x-axis of the graph denotes chronological progress along the user session timeline, with each timestamp corresponding to the initiation point of specific events. The y-axis represents the temporal duration of events.

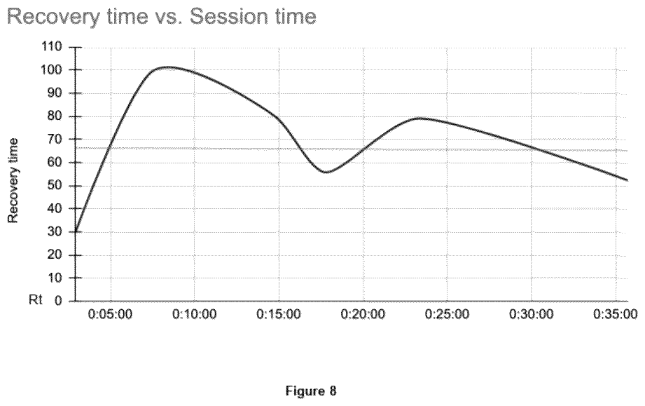

Referring to FIG. 8, a graph of client attention recovery time is depicted, according to an embodiment. The graph of FIG. 8 is directly connected to a formula that quantifies the rate at which users regain focus after being distracted during their interaction with digital content. In one embodiment the graph's purpose is to showcase the attention recovery time parameter (Rt), which quantifies the time taken by a user to re-engage with content after an interruption. In another embodiment the formula used to compute Rt is grounded in the analysis of two arrays: the Focused (Focus time) [Fc (t)] and Interruption [I(t)] arrays. The comprehensive approach accounts for both focused engagement and interruptions in the user's interaction. The goal is to determine Rt, which reflects the user's cognitive ability to refocus. The parameter is calculated within the temporal context of the user's session and reveals critical insights into their attention dynamics. The formula for calculating Rt is as follows: Rt=|(Fck*(t (x+1)−tx))/(I_maxF-Fck)|. In this equation, Fck represents a focused event's value, and t (x+1)−tx represents the time interval between two consecutive focused events. The maximum value of the Interruption event [|I(t)|] in the interval [Fck−1, Fck] plays a significant role in the calculation by plotting this calculated Rt against the session timeline, as illustrated in FIG. 8, gains a visual representation of how quickly users rebound from distractions. The graphical depiction complements the formula's numerical insights, offering a comprehensive view of user attention recovery patterns.

In another embodiment, the engagement analysis system takes a proactive approach to address instances of low student engagement during their interaction with digital content. Embodiments leverage sophisticated algorithms to evaluate the interplay between focus time and interruption time values, thereby gauging the extent of student engagement. More specifically, this approach is implemented in systems depicted in, for example, FIGS. 7 and 8, where advanced algorithms analyze focus time and interruption time values to assess student engagement levels. When the focus time value falls below the interruption time value by 20% or more, indicating a low level of engagement, the system introduces a series of strategic measures to rejuvenate the student's interest and commitment to the content. In other embodiments, when the focus time value falls below the interruption time value by other thresholds such as 5%, 10%, 15%, 25%, 30%, 35%, or 40% or more, strategic measures can likewise be implemented. Embodiments thereby underscore the dedication to fostering a supportive and engaging learning environment for all students.

The system's response to low engagement levels encompasses a comprehensive array of strategies that collectively empower students to re-engage with the material. The strategies are thoughtfully designed to address diverse learning preferences, ensuring that every student is offered avenues for revitalizing their educational journey. Example strategies are set out below.
1. Content personalization: recognizing that personalization fosters interest, the system tailors the course content to align with students' individual preferences. This can include adjusting the pacing of presentations, incorporating alternative examples, or introducing varied learning formats such as text, video, and audio materials.
2. Interactivity enhancement: the system elevates interactivity by infusing elements of gamification, quizzes, and interactive activities into the material. These activities require active participation, encouraging students to engage with the content in dynamic and immersive ways.
3. Feedback loop: the system collaborates with educator users by notifying educator users when students exhibit signs of low engagement. Educator users can then offer personalized support through additional consultations, helping students navigate challenges and regain focus.
4. Community engagement: to foster a sense of community, the system facilitates student interactions through forums and group chats. Such platforms provide opportunities for students to share experiences, seek assistance, and collaborate with peers.
5. Reminders and motivation: The system sends timely reminders for impending deadlines and offers motivational messages or rewards for achieving learning milestones. This approach nurtures a sense of accomplishment and commitment.
6. Tailoring to preferences: Acknowledging individual learning preferences, the system tailors content to cater to students' interests, learning styles, and other factors that influence engagement and motivation.
7. Independent learning support: to bolster independent learning skills, the system equips students with tools and resources, such as educational videos, checklists, and mobile apps. These resources empower students to manage their studies effectively and remain engaged.
8. Real-time interactions: organizing regular webinars and workshops provides students with real-time engagement opportunities. These sessions enable direct interaction with faculty and peers, thereby revitalizing interest and promoting active participation.
9. Collaborative projects: group assignments and collaborative projects promote knowledge sharing.

A content adjustment mechanism is integrated to dynamically respond to fluctuations in user engagement during digital content interactions. This mechanism is particularly crucial in e-learning environments where maintaining user interest is key. When the system identifies a decrease in audience engagement, it activates specific strategies to reinvigorate learner participation.

In one embodiment, content adjustment includes the deployment of interactive elements. For instance, if a drop in attention is observed, the system prompts the instructor with suggestions to engage the audience, like initiating an interactive poll. This prompt includes a straightforward activation method, allowing the instructor to seamlessly integrate the suggested activity into the ongoing session.

Further strategies include the introduction of Q&A sessions to encourage learner participation and quizzes to assess and stimulate knowledge retention. The system also facilitates more visual and collaborative learning experiences, such as whiteboard sessions for brainstorming and idea visualization. For enhanced group interaction, it suggests transitioning to collaborative activities, like breakout room discussions, enhancing the dynamism of the learning experience.

Additionally, the system tailors the content delivery pace in response to detected audience fatigue or overwhelm. It might suggest modulating the pace or introducing breaks to align with the learners' absorption capabilities. For complex topics, the incorporation of interactive simulations or demonstrations is suggested, making the learning process more engaging and practical.

In one embodiment, the content adjustment module is integral for personalizing the e-learning experience, dynamically modifying digital content to align with individual user preferences and learning styles. This adaptive customization is deeply rooted in established educational principles and user-provided preferences, ensuring an effective and personalized learning journey. The module discerns unique learning inclinations and preferences, whether they are visual, auditory, kinesthetic, or a combination thereof, and tailors the content delivery accordingly. For instance, visual learners benefit from enhanced graphical content, auditory learners from enriched audio elements, and kinesthetic learners from interactive and practical exercises. The content adjustment module incorporates user-provided feedback to refine the learning experience continually. It adjusts content pacing, complexity, and format based on direct user input, catering to each learner's specific needs and preferences. This user-centric approach enables the system to adapt the curriculum's challenge level and presentation, ensuring maximum engagement and comprehension. Additionally, the provision of supplementary materials such as quizzes, readings, or project work complements the core content, creating a rich, multifaceted educational environment. This level of personalization in the e-learning platform signifies a significant advancement in digital education, transforming personalized learning into a practical and impactful reality.

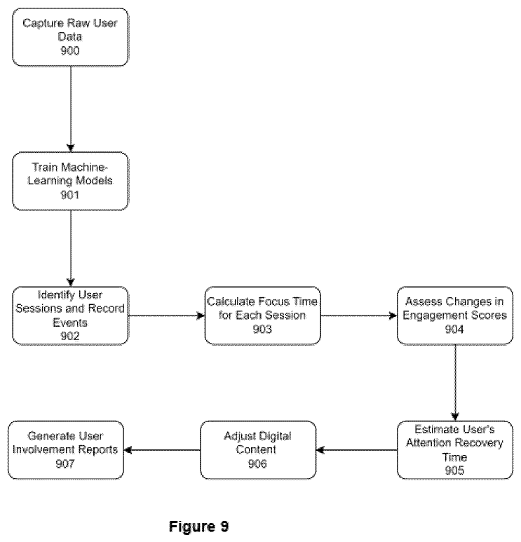

Referring to FIG. 9, a flowchart of a method for measuring user engagement during digital content interaction is depicted, according to an embodiment. In an embodiment, the method utilizes machine learning and user data analysis to optimize the learning experience. At 900, raw data content is captured from the user's device. This data includes video images from a camera, input data from input/output devices like keyboards and mice, data related to application activities, and system events data. After data capture, machine-learning models are trained to analyze this collected user data at 901. The models serve specific purposes, including face detection, emotion detection, focus detection, and user activity detection. User sessions are identified and defined at 902. During these sessions, various events are recorded. The events represent actions and behaviors of the user while interacting with digital content. For instance, events can indicate actions like reading, writing, modifying, or other interactions with the content. The method calculates the total time during each user session at 903 in which the user is focused on the content. Changes in user engagement scores are evaluated throughout each user session at 904. The scores are influenced by recorded events, event parameters, and focus time. The recorded events provide insights into how engaged the user is with the content. The duration is referred to as “focus time” and measures the user's engagement with the material. The method also estimates how quickly a user regains focus on the content after being distracted at 905. At 905 the time interval between focused events and interruptions is analyzed. The method dynamically adjusts the digital content at 906 provided to the user based on metrics like the calculated engagement score, focus time, and attention recovery time. Adjustments can include altering content delivery, format, or introducing interactive elements. Finally, the method generates reports at 907 summarizing user engagement metrics and content effectiveness. The reports at 907 offer insights into how users are interacting with the material.

1. A computer-implemented method for measuring user engagement while interacting with digital content, the method comprising:
collecting user data including video images from a camera, input data from an input/output device, application activity data, and system events data;
applying a plurality of machine-learning models, wherein the machine-learning models are configured to analyze footage and a dataset for face training and to analyze the collected user data, wherein the plurality of machine-learning models includes models for face detection, emotion detection, focus detection, and user activity detection;
associating each user session with corresponding events and event parameters output from at least one of the machine-learning models;
calculating the total time of user focus based on marked events and event parameters for each user session as a focus time, wherein the marked events reflect the total time of user focus;
assessing changes in user engagement scores throughout each user session using the marked events, the event parameters, and the focus time;
estimating an attention recovery time; and
adjusting the digital content provided to a particular user based on at least one calculated engagement score, the focus time, and the attention recovery time.

2. The method of claim 1, further comprising generating personalized content recommendations based on the engagement scores and the focus time.

3. The method of claim 1, wherein adjusting the digital content comprises altering the pacing of content delivery to match a certain engagement score.

4. The method of claim 1, wherein adjusting the digital content comprises modifying the format of content presentation to align with preferences.

5. The method of claim 1, wherein adjusting the digital content comprises incorporating interactive elements, quizzes, or gamification to increase engagement scores.

6. The method of claim 1, wherein adjusting the digital content includes transitioning from a text-based format to a graphic-based format, based on user engagement patterns.

7. The method of claim 1, wherein adjusting the digital content comprises modifying the difficulty level of the content, either increasing complexity for high user engagement scores or simplifying content for lower engagement scores.

8. The method of claim 1, further comprising generating at least one report summarizing engagement metrics, wherein the engagement metrics includes a set of quantifiable measurements related to user interaction and involvement with digital content, including user focus duration, emotional responses, or activity patterns.

9. The method of claim 1, wherein the machine-learning models are continuously updated and improved based on newly collected user data to enhance detection accuracy.

10. The method of claim 1, wherein adjusting the digital content is performed in real-time based on a current engagement level during a session, where the current engagement level during a session is a dynamically assessed degree of user involvement and interaction with the digital content.

11. The method of claim 1, wherein the user data includes physiological data, and the machine-learning models for emotion detection utilize physiological signals to assess emotional states.

12. A system for measuring user engagement while interacting with digital content, comprising:
a data collection module configured to capture user interactions, including screen images, webcam video, device inputs, application activities, and system events as collected data;
an engagement analysis service configured to process the collected data and generate raw engagement events by correlating and filtering collected data;
a data aggregation module configured to aggregate the raw engagement events, and generate an individual client metric and a group metric as aggregated data;
a reporting module configured to receive the aggregated data and provide a visual representation of engagement data over time using a graphical monitoring interface; and
a content adjustment module configured to collaborate with a Learning Management System (LMS) to dynamically modify the digital content based on the engagement data.

13. The system of claim 12, wherein the data collection module is at least one of a desktop screening unit, a web-camera control unit, a system events control unit, or an application activity control unit.

14. The system of claim 12, wherein the data collection module captures screen interactions, device inputs, application activities, system events, or webcam video.

15. The system of claim 12, wherein the data aggregation module aggregates raw engagement events.

16. The system of claim 12, wherein the digital content is dynamically modified to adapt to an individual user based on an educational principle or a user-provided preference.

17. The system of claim 12, wherein the digital content is dynamically modified by altering the pacing of content delivery to match a certain engagement level.

18. The system of claim 12, wherein the digital content is dynamically modified by modifying the format of content presentation to align with preferences.

19. The method of claim 12, wherein the digital content is dynamically modified by incorporating interactive elements, quizzes, or gamification to increase engagement.

20. The system of claim 12, wherein the digital content is dynamically modified by transitioning from a text-based format to a graphic-based format, based on user engagement patterns.
